(19) United States
(12) Patent Application Publication
(10) Pub. No.: US 2024/0250371 A1
(43) Pub. Date: Jul. 25, 2024

(54) BATTERY PACK

(71) Applicant: SAMSUNG SDI CO., LTD., Yongin-si (KR)

(72) Inventor: Yusik Hwang, Yongin-si (KR)

(21) Appl. No.: 18/521,807

(22) Filed: Nov. 28, 2023

(30) Foreign Application Priority Data
Jan. 25, 2023 (KR) 10-2023-0009575
Nov. 23, 2023 (KR) 10-2023-0164517

(51) Int. Cl. H01M 50/264; H01M 50/233

(52) U.S. Cl. CPC H01M 50/264; H01M 50/233

(57) ABSTRACT

A battery pack includes: a plurality of battery units arranged along a first axis; and a binding mechanism configured to provide a binding force to physically bind together the plurality of battery units. The binding mechanism includes: a front end plate and a rear end plate respectively at outer sides of one end position and another end position of the plurality of battery units along the first axis; a pair of side plates connecting the front end plate and the rear end plate to each other and extending across side surfaces of the plurality of battery units; and a coupling mechanism connecting at least one of the front end plate and the rear end plate with the pair of side plates.

### CROSS-REFERENCE TO RELATED APPLICATION

The present application claims priority to and the benefit of Korean Patent Application No. 10-2023-0009575, filed on Jan. 25, 2023, and Korean Patent Application No. 10-2023-0164517, filed on Nov. 23, 2023, in the Korean Intellectual Property Office, the entire disclosure of which is incorporated herein by reference.

### BACKGROUND

### 1. Field

Aspects of embodiments of the present disclosure relate to a battery pack.

### 2. Description of the Related Art

Secondary batteries are batteries that are designed to be charged and discharged, unlike primary batteries, which are not designed to be charged. Secondary batteries are used as an energy source for mobile devices, electric vehicles, hybrid vehicles, electric bicycles, uninterruptible power supplies, and more. Depending on external device to be powered, a secondary battery may be used (or implemented) as a single cell or as a module or pack including multiple cells connected together as a single unit.

### SUMMARY

Embodiments of the present disclosure provide a battery pack that includes a binding mechanism for physically binding together a plurality of battery units to effectively compress an electrode assembly inside the battery units via a binding force physically binding the plurality of battery units.

Embodiments of the present disclosure also provide a battery pack that, through effective compression of an electrode assembly, may prevent deterioration of output characteristics of the electrode assembly while including a plurality of electrode layers to provide high output with high capacity and high voltage.

Additional aspects and features of the present disclosure will be set forth, in part, in the description which follows and, in part, will be apparent from the description or may be learned by practice of the described embodiments of the present disclosure.

A battery pack, according to an embodiment of the present disclosure, includes: a plurality of battery units arranged along a first axis; and a binding mechanism configured to provide a binding force to physically bind together the plurality of battery units. The binding mechanism includes: a front end plate and a rear end plate respectively at outer sides of one end position and another end position of the plurality of battery units along the first axis; a pair of side plates connecting the front end plate and the rear end plate to each other and extending across side surfaces of the plurality of battery units; and a coupling mechanism connecting at least one of the front end plate and the rear end plate with the pair of side plates.

The binding mechanism may be configured to compressive the plurality of battery units.

The binding mechanism may be configured to provide a compressive force to one side or both sides of the plurality of battery units. If (e.g., when) a first thickness is a total thickness of the plurality of battery units after being compressed by the binding mechanism and a second thickness is a total thickness of the plurality of battery units arranged along the first axis before being compressed by the binding mechanism, the first thickness may be 99% or less of the second thickness.

The coupling mechanism may further include: a first coupling member integrally formed with the front end plate; and a second coupling member coupled to the first coupling member and opposing a second side of the rear end plate.

The coupling mechanism may further include a first coupling member and a second coupling member. The first coupling member may include: a protruding portion contacting a second side of the front end plate; and an extending portion extending from the protruding portion. The second coupling member may be coupled to the first coupling member and may oppose a second side of the rear end plate.

The front end plate may have an end plate through-hole therein, the pair of side plates may each have a side plate through-hole formed therein, and the rear end plate may have an end plate coupling hole formed therein.

The first coupling member may sequentially pass through the end plate through-hole, the side plate through-hole, and the end plate coupling hole, and the second coupling member may be coupled to an end of the first coupling member having sequentially passed through the end plate through-hole, the side plate through-hole, and the end plate coupling hole.

The end plate through-hole may be in an area of the front end plate on a plane of contact between the front end plate and the pair of side plates.

The side plate through-hole may be within the side plates and may extend parallel to the first axis.

The end plate coupling hole may be in an area of the rear end plate on a plane of contact between the rear end plate and the pair of side plates.

The coupling mechanism nay further include a plurality of the first coupling members and a plurality of the second coupling members, and a number of each of the end plate through-holes, the side plate through-holes, and the end plate coupling holes may correspond to a number of the first coupling members and a number of the second coupling members.

The front end plate may have a plurality of the end plate through-holes, and the plurality of end plate through-holes may be adjacent in a direction parallel to a plane of contact between the front end plate and the pair of side plates and perpendicular to the first axis.

The plurality of end plate through-holes may be spaced apart from each other.

The pair of side plates may each have a plurality of the side plate through-holes arranged along a plane of contact between the side plates and the pair of end plates, and any one of the side plate through-holes may extend in a direction perpendicular to the plane of contact between the side plates and the pair of end plates and parallel to the first axis.

The plurality of side plate through-holes may be spaced apart from each other.

The rear end plate may have a plurality of the end plate coupling holes, and the plurality of end plate coupling holes may be adjacent to each other in a direction parallel to a plane of contact between the rear end plate and the pair of side plates and perpendicular to the first axis.

The plurality of end plate coupling holes may be spaced apart from each other.

Each of the plurality of battery units may include: an electrode assembly including a plurality of electrode layers stacked along the first axis; and a case accommodating the electrode assembly.

The electrode assembly may further include an electrolyte layer between the electrode layers having different polarities from each other along the first axis. The electrolyte layer may include at least one of: a liquid electrolyte, a solid electrolyte including an oxide-based solid electrolyte, a sulfide-based solid electrolyte, a polymer solid electrolyte, or a combination thereof, at least a part of the solid electrolyte being sintered by a compressive force provided by the binding mechanism; and a gel electrolyte including a polymer gel electrolyte.

The electrode layers may include a cathode layer and an anode layer. The cathode layer may include a cathode current collector, and the anode layer may include an anode current collector. At least one of the cathode current collector and the anode current collector may include a base film and a metal layer on at least one side of the base film. The base film may include a polymer including polyethylene terephthalate (PET), polyethylene (PE), polypropylene (PP), polybutylene terephthalate (PBT), polyimide (PI), or a combination thereof, and the metal layer may include indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

### BRIEF DESCRIPTION OF THE DRAWINGS

The above and other aspects and features of the present disclosure will be more apparent from the following description, taken in conjunction with the accompanying drawings, in which:

FIG. 1 is an exploded perspective view of a battery pack according to embodiments of the present disclosure;

FIG. 2 is a perspective view of a binding mechanism illustrated in FIG. 1;

FIG. 3 is a perspective view of a part of the binding mechanism illustrated in FIG. 2;

FIG. 4 is a perspective view illustrating a part of a binding mechanism included in a battery pack according to another embodiment of the present disclosure;

FIG. 5 is a cross-sectional view taken along the line A-A in FIG. 2 with some components omitted for ease of description;

FIG. 6 is a cross-sectional view taken along the line A-A in FIG. 2;

FIG. 7 is a cross-sectional view of the assembled components illustrated in FIG. 6;

FIG. 8 is a perspective view of some components of the binding mechanism illustrated in FIG. 2;

FIG. 9 is a perspective view of the battery units illustrated in FIG. 1;

FIG. 10 is a cross-sectional view taken along the line D-D in FIG. 9; and

FIG. 11 is a diagram for describing a configuration of an electrode assembly illustrated in FIG. 10.

### DETAILED DESCRIPTION

Reference will now be made in detail to embodiments, examples of which are illustrated in the accompanying drawings. The described embodiments may have different forms and should not be construed as being limited to the descriptions set forth herein. Accordingly, the embodiments are merely described below, by referring to the figures, to explain aspects and features of the present description.

It will be understood that when an element or layer is referred to as being “on,” “connected to,” or “coupled to” another element or layer, it may be directly on, connected, or coupled to the other element or layer or one or more intervening elements or layers may also be present. If (e.g., when) an element or layer is referred to as being “directly on,” “directly connected to,” or “directly coupled to” another element or layer, there are no intervening elements or layers present. For example, if (e.g., when) a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if (e.g., when) describing embodiments of the present disclosure relates to “one or more embodiments of the present disclosure.” Expressions, such as “at least one of” and “any one of,” if (e.g., when) preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if (e.g., when) used in this specification, specify the presence of stated features, integers, steps, operations, elements, and/or components but do not preclude the presence or addition of one or more other features, integers, steps, operations, elements, components, and/or groups thereof.

Hereinbelow, a battery pack according to embodiments of the present disclosure will be described with reference to the accompanied drawings.

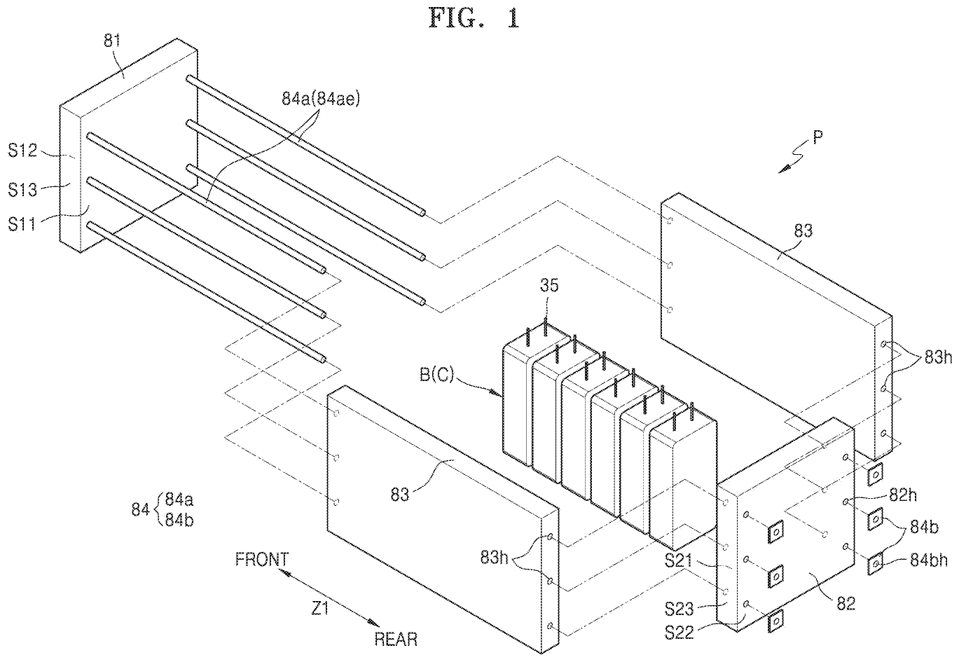

FIG. 1 is an exploded perspective view of a battery pack P according to embodiments of the present disclosure.

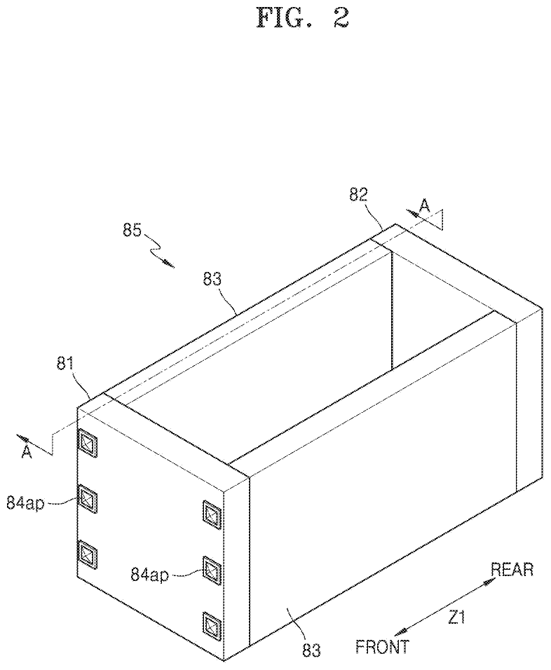

FIG. 2 is a perspective view of a binding mechanism 85 illustrated in FIG. 1.

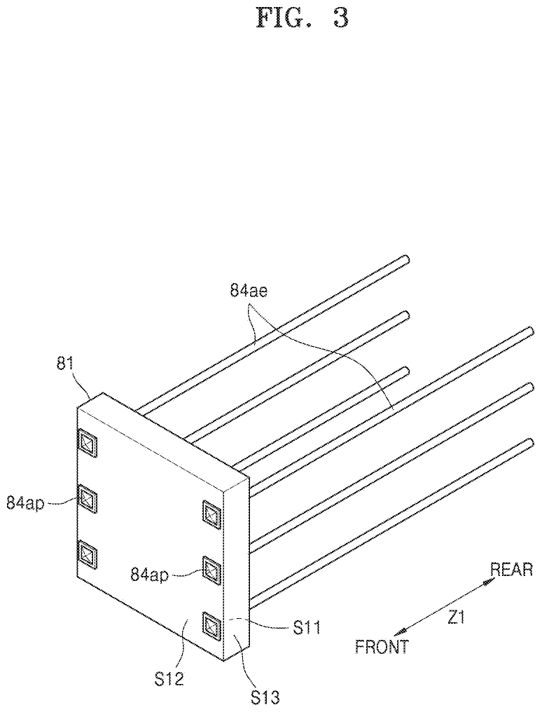

FIG. 3 is a perspective view of a part of the binding mechanism 85 illustrated in FIG. 2.

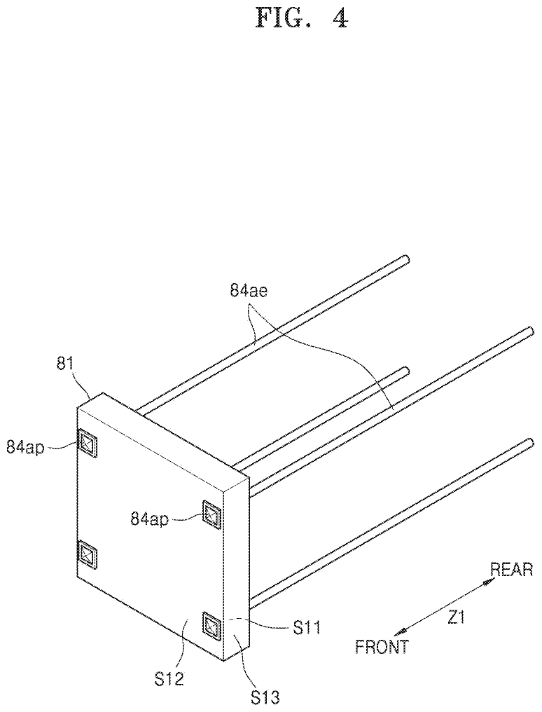

FIG. 4 is a perspective view illustrating a part of a binding mechanism 85 included in a battery pack according to another embodiment of the present disclosure.

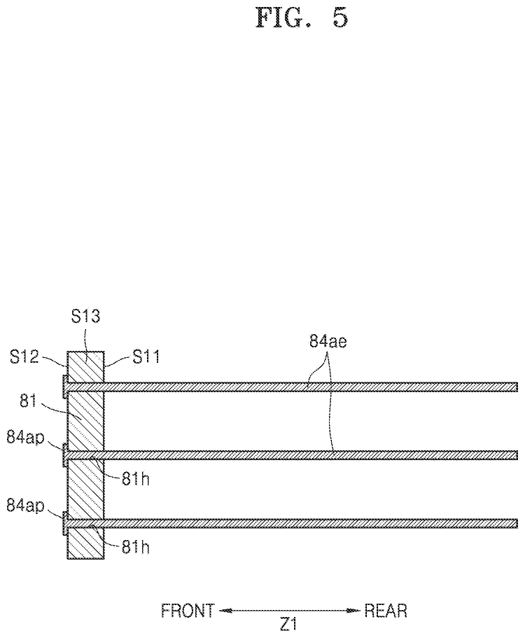

FIG. 5 is a cross-sectional view, with some components omitted, of the battery pack P taken along the line A-A in FIG. 2.

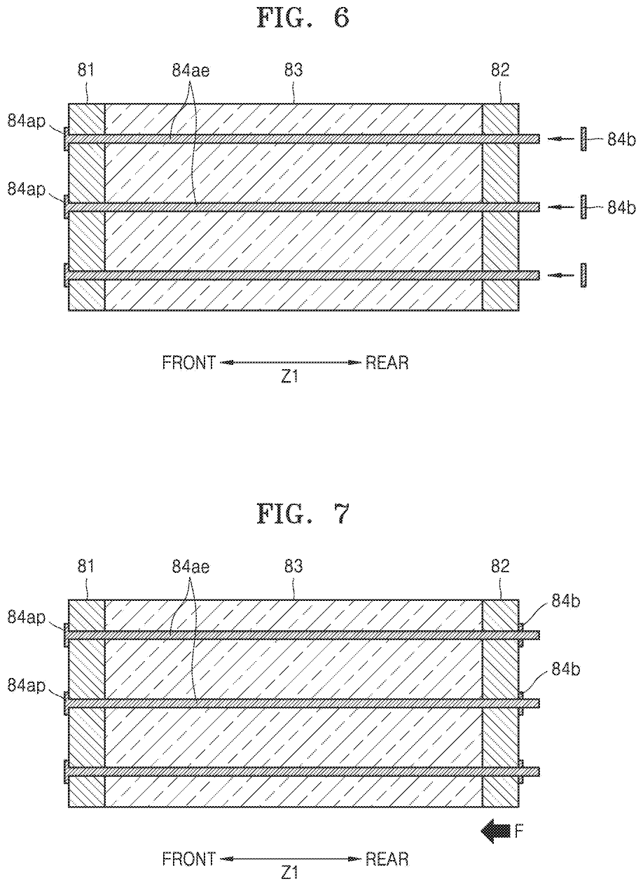

FIG. 6 is a cross-sectional view of the battery pack P, taken along the line A-A in FIG. 2.

FIG. 7 is a cross-sectional view of the assembled components illustrated in FIG. 6.

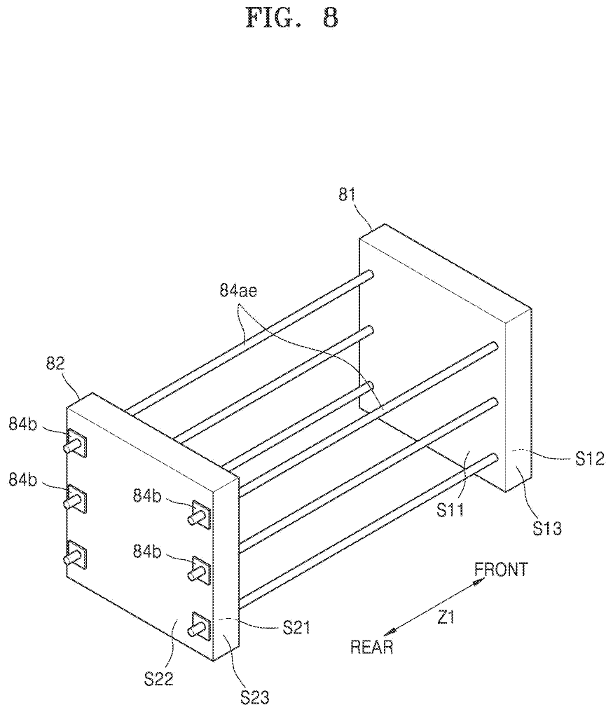

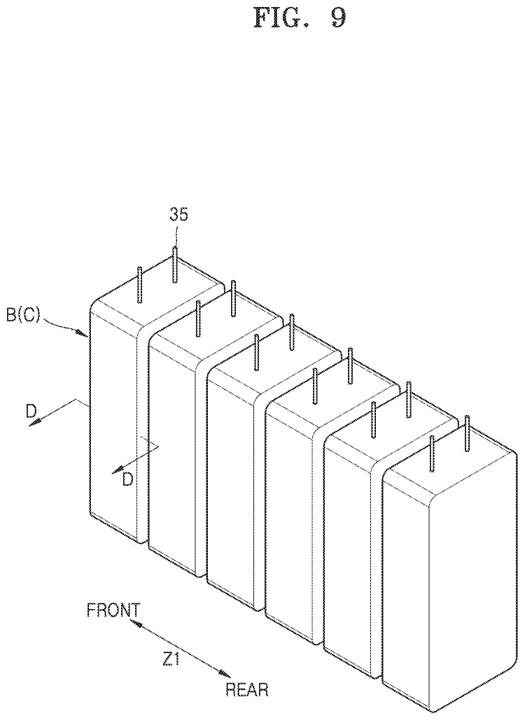

FIG. 8 is a perspective view of some components of the binding mechanism 85 illustrated in FIG. 2, viewed from behind.

FIG. 9 is a perspective view of the battery units B illustrated in FIG. 1.

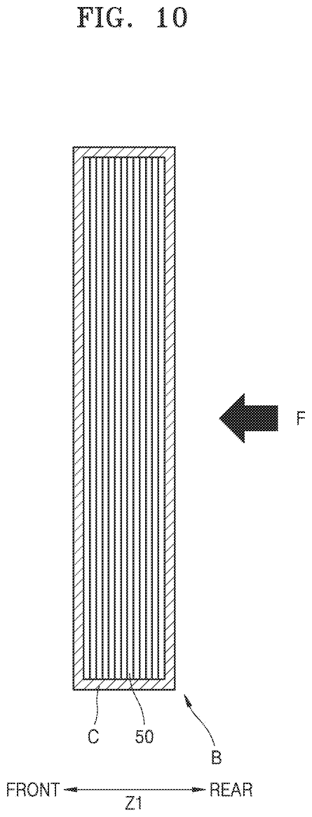

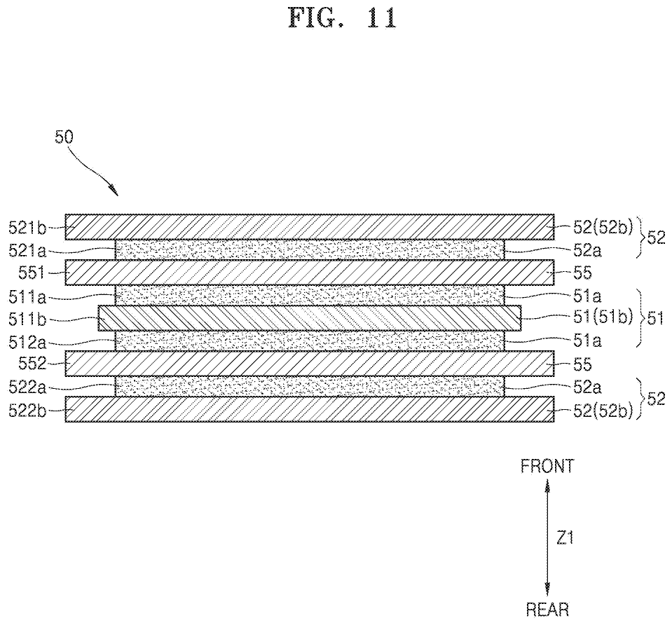

FIG. 10 is a cross-sectional view of one of the battery units B taken along the line D-D in FIG. 9.

FIG. 11 is a diagram for describing the configuration of an electrode assembly 50 illustrated in FIG. 10.

Referring to FIG. 1, the battery pack P, according to embodiments of the present disclosure, may include a plurality of battery units B arranged along a first axis Z1 and a binding mechanism 85 providing a binding force to physically bind together the plurality of battery units B arranged along the first axis Z1.

In one or more embodiments of the present disclosure, the binding mechanism 85 may include, surrounding outer peripheral surfaces of a plurality of battery units B arranged along the first axis Z1, a plurality of plates 81, 82, 83, which have joint portions formed with respect to each other along the outer peripheral surfaces of the plurality of battery units B.

For example, the binding mechanism 85 may include a pair of end plates 81, 82, and a pair of side plates 83. The pair of end plates 81, 82 includes a front end plate 81 and a rear end plate 82 disposed on the outside of a frontmost battery unit B and the outside of a rearmost battery unit B, respectively, that define one end position and the other end position in an array of the plurality of battery units B arranged along the first axis Z1, respectively. The pair of side plates 83 extend across side surfaces of the plurality of battery units B along the first axis Z1 and connect the front end plate 81 and the rear end plate 82 to each other.

In some embodiments, the front end plate 81 may be the rear end plate 82, and the rear end plate 82 may be the front end plate 81, and as such, these components are not limited by these terms and may be used interchangeably.

The pair of side plates 83 may be connected to the pair of end plates 81, 82 by a coupling mechanism 84, thereby providing a binding force and a compressive forced as described in more detail herein. In some embodiments, the rear end plate 82 may include the pair of side plates 83 (e.g., the rear end plate 82 may be integrally formed with the pair of side plates 83).

The pair of side plates 83 may form outer peripheral surfaces of the battery pack P as well as ensure structural stability of the coupling mechanism 84. As described below, because one component of the coupling mechanism 84 is configured to pass through the side plates 83, even if the one component of the coupling mechanism 84 extends and connects the pair of end plates 81, 82 spaced apart from each other, the coupling mechanism 84 may not deform. At the same time, because the pair of end plates 81, 82 are connected to each other by the coupling mechanism 84, structural stability of the battery pack P may be ensured.

Further, a battery pack P according to one or more embodiments of the present disclosure may include at least one of an upper plate or a lower plate, positioned on an upper part or lower part of the battery unit B, respectively, to form outer peripheral surfaces of the battery pack P.

Each of the front end plate 81 and the rear end plate 82 may include sides. The sides forming the exterior of the front end plate 81 may include a first side S11 and a second side S12, facing each other along the first axis Z1 corresponding to an arrangement direction of battery units B, and a side surface S13 connecting between (or extending between) the first side S11 and the second side S12. The first side S11, the second side S12, and the side surface S13 may be referred to as a first side S11, a second side S12, and a side surface S13 of the front end plate 81. The sides forming the exterior of the rear end plate 82 may include a first side S21 and a second side S22, facing each other along the first axis Z1 corresponding to an arrangement direction of battery units B, and a side surface S23 connecting between (or extending between) the first side S21 and the second side S22. The first side S21, the second side S22, and the side surface S23 may be referred to as a first side S21, a second side S22, and a side surface S23 of the rear end plate 82.

The first side S11 and the second side S12 of the front end plate 81 may indicate one side and the other side of the front end plate 81, facing each other along the first axis Z1, and the first side S21 and the second side S22 of the rear end plate 82 may indicate one side and the other side of the rear end plate 82, facing each other along the first axis Z1. Further, the first side S11 of the front end plate 81 and the first side S21 of the rear end plate 82 may indicate the inner side of the front end plate 81 or the rear end plate 82, respectively, that face the battery units B or a plurality of cases C forming the exterior of the battery units B. Further, the second side S12 of the front end plate 81 and the second side S22 of the rear end plate 82 may indicate the outer side surface of the front end plate 81 or the rear end plate 82, respectively, that form the exterior of the battery pack P.

The first axis Z1 may correspond to a front-rear direction in which the plurality of battery units B are arranged or a front-rear direction in which the plurality of cases C forming the exterior of the plurality of battery units B are arranged. Throughout the present disclosure, the front-rear direction in which the plurality of battery units B are arranged and the front-rear direction in which the plurality of cases C are arranged may both be referred to as the first axis Z1.

Referring to FIG. 2, in one or more embodiments of the present disclosure, the binding mechanism 85 may include, as one form in which the plurality of plates 81, 82, 83 have joint portions formed with respect to each other, a coupling mechanism 84 that connects at least one end plate 81 or 82 from among the pair of end plates 81, 82 to the pair of side plates 83.

The coupling mechanism 84 may connect the front end plate 81 to at least one side plate 83 from among the pair of side plates 83 and/or may connect the rear end plate 82 to at least one side plate 83 from among the pair of side plates 83. In some embodiments, the coupling mechanism 84 may connect the front end plate 81 to each of the pair of side plates 83 or may connect the rear end plate 82 to each of the pair of side plates 83. In some embodiments, the coupling mechanism 84 may connect the front end plate 81 and the side plate 83, and while they are connected to each other, to the rear end plate 82 and may connect the rear end plate 82 and the side plate 83, and while they are connected to each other, to the front end plate 81.

In one or more embodiments of the present disclosure, the coupling mechanism 84 may provide a binding force for physically binding the plurality of battery units B together by forming a connection among the front end plate 81, the side plates 83, and the rear end plate 82. For example, because the coupling mechanism 84 is formed along the first axis Z1, the coupling mechanism 84 may provide a binding force in the direction of the first axis Z1 to the plurality of battery units B arranged along the first axis Z1.

In one or more embodiments of the present disclosure, the binding mechanism 85 may provide a compressive force to the plurality of battery units B arranged along the first axis Z1.

The binding mechanism 85 may include a pair of end plates 81, 82, a pair of side plates 83, and a coupling mechanism 84 for connecting at least one end plate 81 or 82 from among the pair of end plates 81, 82 to the pair of side plates 83. The pair of end plates 81, 82 includes a front end plate 81 and a rear end plate 82 disposed on the outside of a frontmost battery unit B and the outside of a rearmost battery unit B, respectively, that define one end position and the other end (e.g., the opposite) position of an array of the plurality of battery units B arranged along the first axis Z1, respectively. The pair of side plates 83 extend across side surfaces of the plurality of battery units B along the first axis Z1 and connect the front end plate 81 and the rear end plate 82 to each other.

The binding mechanism 85 may provide a compressive force to the plurality of battery units B by connecting the pair of end plates 81, 82 to the pair of side plates 83 and including the coupling mechanism 84 for this connection. The end plates 81, 82 are disposed on the outside of a foremost battery unit B and on the outside of a rearmost battery unit B, respectively, in an array of the plurality of battery units B arranged along the first axis Z1.

As will be described below, it is desirable to provide a compressive force in the event of interface issues due to solid electrolytes in an electrode assembly 50 including a solid electrolyte, a battery unit B including the same, and a battery pack P including an array of a plurality of the battery unit B. However, a conventional battery pack does not provide a pressure at the pack level and fails to resolve issues of poor interfacial contact between solid electrolytes and anode layers or poor interfacial contact between solid electrolytes and cathode layers.

In this context, a battery pack P, according to one or more embodiments of the present disclosure, may address interfacial issues due to solid electrolytes by using a binding mechanism 85 to provide an effective pressure and compressive force to a plurality of battery units B and an electrode assembly 50 inside of the battery units B.

In one or more embodiments of the present disclosure, the binding mechanism 85 may provide a compressive force to, from among the side surfaces of the battery unit B, one side or both sides of the battery unit B arranged along the first axis Z1.

As described above, the binding mechanism 85 may be formed to surround outer peripheral surfaces of a plurality of battery units B and may include a coupling mechanism 84 that connects a pair of end plates 81, 82 and a pair of side plates 83 to each other.

The coupling mechanism 84 may connect a front end plate 81, any one side plate 83 from among the pair of side plates 83, and a rear end plate 82 arranged along a first axis Z1. Thus, because a binding force or a compressive force is imparted through the front end plate 81, any one side plate 83 from among the pair of side plates 83, and the rear end plate 82 arranged along the first axis Z1 being flush against each other, the binding force or compressive force may be sequentially transmitted to battery units B adjacent to the front end plate 81 and the rear end plate 82. Thus, the binding mechanism 85 may provide a compressive force to one side or both sides, arranged along the first axis Z1, of side surfaces of the plurality of battery units B.

In one or more embodiments of the present disclosure, the compressive force may be transmitted to the array of battery units B from the front end plate 81 or from the rear end plate 82. Thus, a compressive force provided by the binding mechanism 85 may be transmitted first to one side of the foremost battery unit B adjacent to the front end plate 81 and to one side of the rearmost battery unit B, and then, the compressive force may be sequentially transmitted to other battery units B adjacent thereto (e.g., to the other battery units B therebetween).

The binding mechanism 85 may provide a compressive force to, from among the side surfaces of the battery units B, one side or both sides of the battery units B arranged along the first axis Z1. If a first thickness is the total thickness of the plurality of battery units B arranged along the first axis Z1 after being compressed by the binding mechanism 85, and a second thickness is the total thickness of the plurality of battery units B arranged along the first axis Z1 before compressed by the binding mechanism 85, the first thickness may be about 99% or less of the second thickness.

The first thickness may be a total thickness of a plurality of battery units B provided in the direction of a first axis Z1 after being compressed by the binding mechanism 85 and may be a total thickness of battery units B illustrated in FIG. 9 after being compressed (or pressed).

The second thickness may be a total thickness of a plurality of battery units B provided in the direction of a first axis Z1 before compressed by the binding mechanism 85 and may be a total thickness of battery units B illustrated in FIG. 9 before being compressed.

Therefore, of the array of the plurality of battery units B provided with a compressive force by the binding mechanism 85, the first thickness may be smaller than the second thickness. The first thickness may be about 99.0% or less relative to the second thickness. The first thickness may be, for example, 99.5% or less, 99% or less, 98% or less, 97% or less, 96% or less, 95% or less, 94% or less, 93% or less, 92% or less, 91% or less, 90% or less, 89% or less, 88% or less, 87% or less, 86% or less, 85% or less, 84% or less, 83% or less, 82% or less, 81% or less, 80% or less, 79% or less, 78% or less, 77% or less, 76% or less, 75% or less, 74% or less, 73% or less, 72% or less, 71% or less, or 70% or less, relative to the second thickness.

In one or more embodiments of the present disclosure, the first thickness and the second thickness may be as shown in Table 1 below.

TABLE 1

| | Before receiving | After receiving |
|---|---|---|
| | compressive force | compressive force |
| Thickness (mm) of battery unit (B) | 31.78 | 22.25 |
| Total thickness (mm) of a plurality | 563.2 | 429.72 |
| of battery units (B) arranged | (Second | (First |
| in first axis (Z1) | thickness) | thickness) |

Thus, the thickness of the battery units B after being compressed by the binding mechanism 85 may be smaller than the thickness of the battery units B before compressed by the binding mechanism 85, and the thickness of the battery units B after being compressed by the binding mechanism 85 may be about 70% of the thickness of the battery units B before compressed by the binding mechanism 85. Further, the first thickness, which is the total thickness of a plurality of battery units B arranged along the first axis Z1 after being compressed by the binding mechanism 85, may be smaller than the second thickness, which is the total thickness of the plurality of battery units B arranged along the first axis Z1 before compressed by the binding mechanism 85, and the first thickness may be about 76% of the second thickness.

A battery pack P disclosed herein may be formed to have a first thickness that is smaller than a second thickness.

Hereinafter, in the battery pack P, according to one or more embodiments of the present disclosure, a binding mechanism 85, and a coupling mechanism 84 included in the binding mechanism 85 will be described in more detail.

Referring to FIGS. 3 to 8, in one or more embodiments of the present disclosure, the coupling mechanism 84 may include a first coupling member 84a integrally formed with the front end plate 81 and a second coupling member 84b coupled to the first coupling member 84a and opposing a second side S22 of the rear end plate 82.

The first coupling member 84a may be formed integrally with the front end plate 81 by an insert injection process. For example, a protruding portion 84ap and an extending portion 84ae, illustrated in FIG. 3, may be formed integrally with the front end plate 81. For example, the extending portion 84ae of the first coupling member 84a integrally formed with the front end plate 81 may be formed to pass through an end plate coupling hole (e.g., an end plate coupling opening) 82h in the rear end plate 82 (see, e.g., FIG. 1), and an end portion of the extending portion 84ae and the second coupling member 84b may be fitted together to form a joint portion.

In one or more embodiments of the present disclosure, the coupling mechanism 84 may include a first coupling member 84a and a second coupling member 84b. The first coupling member 84a may be formed integrally with the front end plate 81, as described above, or in other embodiments, may be formed separately from the front end plate 81.

The first coupling member 84a may include a protruding portion 84ap in contact with the second side S12 of the front end plate 81 and an extending portion 84ae extending from the protruding portion 84ap. The second coupling member 84b may be coupled with the first coupling member 84a, while opposing the second side S22 of the rear end plate 82. Here, the expression “opposing” may mean that the corresponding components may face each other or may be adjacent to each other. For example, the second coupling member 84b may be coupled with the first coupling member 84a while contacting the second side S22 of the rear end plate 82, and in some embodiments, may be flush against the second side S22 of the rear end plate 82. By varying the degree to which the second coupling member 84b is flush against the second side S22 of the rear end plate 82, the strength of compressive force with respect to the plurality of battery units B may be adjusted. Therefore, to provide a relatively low level of compressive force, the degree to which the second coupling member 84b is flush against the second side S22 of the rear end plate 82 may be adjusted to be low, and to provide a relatively high level of compressive force, the degree to which the second coupling member 84b is flush against the second side S22 of the rear end plate 82 may be adjusted to be high.

A battery pack P, according to one or more embodiments of the present disclosure, may include at least one end plate through-hole 81h formed in a front end plate 81, at least one side plate through-hole 83h formed in a pair of side plates 83, and at least one end plate coupling hole 82h formed in a rear end plate 82.

The end plate through-hole 81h may be formed in an area of the front end plate 81 that corresponds to a plane of contact between the front end plate 81 and the pair of side plates 83. The area of the front end plate 81 may refer to an area of the front end plate 81 that overlaps with any one side plate 83 from among the pair of side plates 83. For example, the area of the front end plate 81 may refer to an area of the front end plate 81 that comes in contact with any one side plate 83 of the pair of side plates 83. For example, because the end plate through-hole 81h formed in the above area is formed to pass through the front end plate 81, the end plate through-hole 81h may be formed such that the end plate through-hole 81h extends from the area on the first side S11 at where the front end plate 81 is in contact with the side plates 83 to the area on the second side S12 of the front end plate 81 by extending across the side surface S13 of the front end plate 81. For example, because the end plate through-hole 81h is formed in an area overlapping between the front end plate 81 and the side plates 83, the first coupling member 84a may pass through the end plate through-hole 81h and may also sequentially pass through a side plate through-hole 83h formed in a side plate 83.

The end plate through-hole 81h may be formed in the front end plate 81 to which the first coupling member 84a is coupled. The first coupling member 84a may be coupled to the front end plate 81 by fitting into the end plate through-hole 81h. Thus, the end plate through-hole 81h may be formed to have a size and shape that correspond to the first coupling member 84a and, for example, may be formed to have a size and shape that correspond to a cross-section of the extending portion 84ae of the first coupling member 84a. The end plate through-hole 81h, which is formed to have a size and shape corresponding to the first coupling member 84a as described above, may further improve the binding force by the coupling mechanism 84.

The side plate through-hole 83h may be formed within the side plate 83. Thus, the side plate through-hole 83h may be formed, as illustrated in FIG. 1, such that the side plate through-hole 83h is only revealed on (e.g., is only open to) a side surface of the side plate 83 that couples to the front end plate 81 or the rear end plate 82 and is not revealed (or exposed) on an inner side surface of the side plate 83 that faces the battery units B or on an outer side surface of the side plate 83 that forms an outer peripheral surface of the battery pack P.

The side plate through-hole 83h may be formed parallel to the first axis Z1. Referring to FIG. 1, FIG. 6, and FIG. 7, the side plate through-hole 83h may be formed to correspond to an extending portion 84ae of a first coupling member 84a formed parallel to the first axis Z1 such that the extending portion 84ae of the first coupling member 84a passes through the side plate through-hole 83h. The extending portion 84ae of the first coupling member 84a may be formed parallel to the first axis Z1, as an example, that secures the binding force and improves ease of assembly between the front end plate 81, the side plates 83, and the rear end plate 82. Therefore, the side plate through-hole 83h may be formed parallel to the first axis Z1, thereby allowing the extending portion 84ae to pass therethrough easily, and as a result, the binding and assembly of the battery pack P may improve.

The end plate coupling hole 82h may be formed in an area of the rear end plate 82 that corresponds to a plane of contact between the rear end plate 82 and the pair of side plates 82. The area of the rear end plate 82 may refer to an area of the rear end plate 82 that overlaps with any one side plate 83 from among the pair of side plates 83. Further, the area of the rear end plate 82 may refer to an area of the rear end plate 82 that comes in contact with any one side plate 83 from among the pair of side plates 83. For example, because the end plate coupling hole 82h formed in the above area is formed to pass through the rear end plate 82, the end plate coupling hole 82h may be formed such that the end plate coupling hole 82h extends from the area on the first side S21, where the rear end plate 82 is in contact with the side plates 83, to the area on the second side S22 of the rear end plate 82 by extending across the side surface S23 of the rear end plate 82. Further, because the end plate coupling hole 82h is formed in an area overlapping between the rear end plate 82 and the side plate 83, the extending portion 84ae of the first coupling member 84a may pass through the end plate coupling hole 82h, and an end portion of the extending portion 84ae may be coupled to the second coupling member 84b to form a joint portion.

However, in some embodiments, the end plate through-hole 81h and the end plate coupling hole 82h may be formed in areas of the front end plate 81 and the rear end plate 82 where the front end plate 81 and the rear end plate 82 are not in contact with the side plates 83. As a result, an additional compressive force may be provided to the battery unit B, which may lead to an effective application of pressure.

A plurality of the first coupling members 84a and a plurality of the second coupling members 84b may be provided. As illustrated in FIGS. 3 and 4, the first coupling members 84a may be provided in a suitable number selected from a range that improves binding strength, compressive strength, and ease of assembly as described herein. The number of the first coupling members 84a provided may be greater than the number of first coupling members 84a illustrated in FIG. 3 or may be smaller than the number of the first coupling members 84a illustrated in FIG. 4. Further, because the second coupling member 84b couples to the first coupling member 84a and forms a joint portion, as with the first coupling member 84a, the second coupling members 84b may be provided in the same number as the number of second coupling members 84b illustrated in FIG. 6 or may be provided in a fewer or greater number than the ones depicted in FIG. 6. Further, the number of the first coupling members 84a and the number of the second coupling members 84b may be identical. For example, in an embodiment in which the first coupling member 84a is present alone or the second coupling member 84b is present alone, the binding force or compressive force, or ease of assembly described herein may be difficult to achieve. Therefore, by providing the same number of the first coupling members 84a and the second coupling members 84b, the binding force or compressive force and ease of assembly described herein may be achieved.

A plurality of the end plate through-hole 81h may be provided. The plurality of end plate through-holes 81h may be formed in an area of the front end plate 81. The plurality of end plate through-holes 81h may be formed or arranged in a direction that is parallel to a plane of contact between the front end plate 81 and the pair of side plates and is perpendicular to the first axis Z1.

Being formed or arranged in a direction parallel to a plane of contact between the front end plate 81 and the pair of side plates 83 and perpendicular to the first axis Z1 may mean a direction in which the plurality of end plate through-holes 81h are arranged, if viewed on a cross-section of the front end plate 81. The direction in which the plurality of end plate through-holes 81h are arranged may be a direction that is parallel to a plane of contact between the front end plate 81 and the pair of side plates 83 but perpendicular to the first axis Z1. For example, referring to FIG. 5, the end plate through-holes 81h may be formed along the horizontal direction of FIG. 5 and may be arranged adjacent to each other in the vertical direction of FIG. 5. Referring to the vertical direction of FIG. 5, the direction in which the plurality of end plate through-holes 81h are arranged may be a direction parallel to a plane of contact between the front end plate 81 and the side plates 83 and perpendicular to the first axis Z1.

Further, the plurality of end plate through-holes 81h may be spaced apart from each other. For example, the plurality of end plate through-holes 81h may be formed and spaced apart from each other in a direction parallel to a plane of contact between the front end plate 81 and the pair of side plates 83 and perpendicular to the first axis Z1. The first coupling members 84a, which pass through the spaced-apart end plate through-holes 81h, may also be spaced apart from each other, and as a binding force is created by the space-apart first coupling members 84a and second coupling members 84b, the binding force imparted to the battery pack P may be further reinforced.

A plurality of the side plate through-hole 83 may be formed. The side plate through-holes 83 may be formed in each side plate 83. For example, the side plate through-holes 83 formed in the pair of side plates 83 may be such that the side plate through-holes 83 formed in one side plate 83 may be symmetric to the side plate through-holes 83 formed in the other side plate 83.

The plurality of side plate through-holes 83h may be formed along a plane of contact between the side plates 83 and the pair of end plates 81, 82. For example, if the side plate through-holes 83h are viewed on a cross-section of the side plates 83, the direction in which the plurality of side plate through-holes 83h are arranged may be a direction that is parallel to a plane of contact between one side plate 83 and the pair of end plates 81, 82. Referring to FIG. 7, the plurality of side plate through-holes 83h may be formed along the horizontal direction of FIG. 7 and may be arranged adjacent to each other in the vertical direction of FIG. 7.

Further, any one side plate through-hole 83h from among the plurality of side plate through-holes 83h may be formed to extend in a direction perpendicular to a plane of contact between the side plates 83 and the pair of end plates 81, 82 and parallel to the first axis Z1. For example, with respect to the one side plate through-hole 83h from among the plurality of side plate through-holes 83h, the one side plate through-hole 83h may be formed to extend parallel to the first axis Z1, and therefore, the extending portion 84ae of the first coupling member 84a extending parallel to the first axis Z1 may be fitted through the one side plate through-hole 83h.

The plurality of side plate through-holes 83h may be spaced apart from each other. In other embodiments, the plurality of side plate through-holes 83h may be formed and spaced apart from each other in a direction parallel to a plane of contact between one side plate 83 and the pair of end plates 81, 82. Referring to FIG. 7, the plurality of side plate through-holes 83h may be formed and spaced apart from each other along a direction in which a plane of contact between the side plates 83 and the pair of end plates 81, 82 is formed (e.g., the vertical direction of FIG. 7).

A plurality of the end plate coupling hole 82h may be provided. The plurality of end plate coupling holes 82h may be formed in an area of the rear end plate 82. The plurality of end plate coupling holes 82h may be formed or arranged in a direction that is parallel to a plane of contact between the rear end plate 82 and the pair of side plates 83 and perpendicular to the first axis Z1.

The direction parallel to a plane of contact between the rear end plate 82 and the pair of side plates 83 and perpendicular to the first axis Z1 may mean a direction in which the plurality of end plate coupling holes 82h are arranged and spaced apart from each other if the plurality of end plate coupling holes 82h are viewed on a cross-section of the rear end plate 82. For example, the direction in which the plurality of end plate coupling holes 82h are arranged may be a direction that is parallel to a plane of contact between the rear end plate 82 and the pair of side plates 83 but perpendicular to the first axis Z1. For example, referring to FIG. 1, the end plate coupling hole 82h may be adjacent to each other along the vertical direction of FIG. 1. For example, referring to the vertical direction of FIG. 1, the direction in which the plurality of end plate coupling holes 82h are arranged may be a direction that is parallel to a plane of contact between the rear end plate 82 and the side plates 83 and perpendicular to the first axis Z1.

The plurality of end plate coupling holes 82h may be spaced apart from each other. For example, the plurality of end plate coupling holes 82h may be formed and spaced apart from each other in a direction that is parallel to a plane of contact between the rear end plate 82 and the pair of side plates 83 but is perpendicular to the first axis Z1. For example, the first coupling members 84a, which passes through the spaced-apart end plate coupling holes 82h, may also be spaced apart from each other, and the space-apart first coupling members 84a may each pass through the end plate coupling holes 82h. Because each of the first coupling members 84a is later coupled by the second coupling member 84b, the binding force, compressive force, and ease of assembly imparted to the battery pack P may be further improved.

For example, the first coupling member 84a may be a bolt, and the second coupling member 84b may be a nut. For example, one end portion of the extending portion 84ae of the first coupling member 84a may have a threaded portion, and the second coupling member 84b may be coupled via the threaded portion.

The end plate through-hole 81h, the side plate through-hole 83h formed in the pair of side plates 83, and the end plate coupling hole 82h may be each formed in a number that corresponds to the number of the first coupling member 84a and the second coupling member 84b. For example, if (e.g., when) the coupling mechanism 84 is formed of a combination of the first coupling member 84a, the end plate through-hole 81h, the side plate through-hole 83h, the end plate coupling hole 82h, and the second coupling member 84b, the binding force and compressive force imparted to the battery pack P may be guaranteed.

For example, the first coupling member 84a may sequentially pass through the end plate through-hole 81h, the side plate through-hole 83h, and the end plate coupling hole 82h. The second coupling member 84b may be coupled to the first coupling member 84a sequentially passing through the end plate through-hole 81h, the side plate through-hole 83h, and the end plate coupling hole 82h.

The protruding portion 84ap of the first coupling member 84a may be affixed in contact with the second side S12 of the front end plate 81, thereby fixing the first coupling member 84a and the front end plate 81 together. If the protruding portion 84ap were omitted, the first coupling member 84a may have a reduced fixing power, thus decreasing the binding force and compressive force imparted to the battery pack P. As such, the binding force and compressive force may be improved due to the protruding portion 84ap.

The extending portion 84ae of the first coupling member 84a may pass through the end plate through-hole 81h, the side plate through-hole 83h, and the end plate coupling hole 82h.

For example, one end portion of the extending portion 84ae of the first coupling member 84a may protrude from the second side S22 of the rear end plate 82, and the one end portion and the second coupling member 84b may be coupled to each other to form a joint portion. As described above, by varying the degree of opposing or being flush against the second side S22 of the rear end plate 82 through coupling of the second coupling member 84b, the level of compressive force described herein may be controlled, and the level of binding force or compressive force to be provided to the battery pack P may be effectively designed as desired.

Further, through the above coupling structures, a binding force and compressive force are provided to the battery pack P, for example, an array of multiple battery units B, effective pressing with respect to a first axis Z1 of the battery units B may be achieved.

Hereinbelow, a configuration of each battery unit B in a battery pack P, according to one or more embodiments of the present disclosure, will be described.

Referring to FIGS. 9 to 11, each battery unit B may include an electrode assembly 50 and a case C accommodating the electrode assembly 50. The case C may be a pouch-type case or a prismatic-type case.

On a side surface of the battery unit B, electrode tabs 35 electrically connected to the electrode assembly 50 may be provided, and the electrode tabs 35 may be connected to electrode layers (e.g., a cathode layer 51 and a anode layer 52, respectively) of the electrode assembly 50 having a different polarity from each other. For example, in one or more embodiments of the present disclosure, from among side surfaces formed along outer peripheral surfaces of the battery units B, the electrode tab 35 may be provided on a short side surface and not on a long side surface. For example, the electrode tab 35 may be provided all on the same short side surfaces of the battery units B.

Referring to FIG. 11, in one or more embodiments of the present disclosure, the electrode assembly 50 may be formed as a bipolar stack structure. For example, from among the cathode layers 51 and the anode layers 52, which are alternatingly arranged along the first axis Z1, at least one cathode layer 51 may face the anode layer 52 from each side thereof so as to be active on both sides, while from among cathode layers 51 and anode layers 52 alternatingly arranged along the first axis Z1, at least one anode layer 52 may face the cathode layer 51 from only one side thereof so as to be active on a single side. For example, in some embodiments of the present disclosure, from among cathode layers 51 and anode layers 52 alternatingly arranged along the first axis Z1, at least one anode layer 52 may face the cathode layer 51 from each side thereof so as to be active on both sides, while from among cathode layers 51 and anode layers 52 alternatingly arranged along the first axis Z1, at least one cathode layer 51 may face the anode layer 52 from only one side thereof so as to be active on a single side.

For example, the electrode assembly 50 may include a bi-cell including, along the first axis Z1, a first anode current collector 521b, a first anode active material layer 521a, a first electrolyte layer 551, a first cathode active material layer 511a, a first cathode current collector 511b, a second cathode active material layer 512a, a second electrolyte layer 552, a second anode active material layer 522a, and a second anode current collector 522b. For example, the electrode assembly 50 may include a structure in which a plurality of the bi-cells of the above structure are stacked along the first axis Z1. For example, in one or more embodiments of the present disclosure, the electrode assembly 50 may include a structure including a plurality of electrode layers such that the capacity and voltage of a battery unit B can varied depending on the desired capacity and voltage. For example, compared to an electrode assembly 50 having a monopolar structure including an anode layer 52, an electrolyte layer 55, and a cathode layer 51, the electrode assembly 50 may provide a higher output with high capacity and high voltage.

In one or more embodiments of the present disclosure, the electrode assembly 50 may be formed as a bipolar stack structure. For example, an anode layer 52 including the first anode current collector 521b and the first anode active material layer 521a may be active on a single side thereof by facing a cathode layer 51 including the first and second cathode active material layers 511a, 512b and the first cathode current collector 511b from only one side thereof. For example, the cathode layer 51 may be active on both sides thereof, by facing one anode layer 52 including the first anode current collector 521b and the first anode active material layer 521a from one side thereof, while facing another anode layer 52 including the second anode current collector 522b and the second anode active material layer 522a from the other side thereof.

In one or more embodiments of the present disclosure, the anode current collector 521b, 522b may include, for example, a base film and a metal layer disposed on one side or both sides of the base film. The base film may include, for example, a polymer. For example, the polymer may be a thermoplastic polymer. For example, the polymer may include polyethylene terephthalate (PET), polyethylene (PE), polypropylene (PP), polybutylene terephthalate (PBT), polyimide (PI), or a combination thereof. The polymer may be an insulating polymer. If (e.g., when) the base film includes a thermoplastic polymer, the base film liquefies in the event of a short circuit, thus preventing a rapid increase in electric current. For example, the base film may be an insulator. The metal layer may include, for example, copper (Cu), stainless steel (SUS), titanium (Ti), iron (Fe), cobalt (Co), nickel (Ni), or an alloy thereof. The metal layer may be disconnected in the event of an overcurrent, thus acting as an electrochemical fuse to provide protection against short circuits. A limiting current and a maximum current may be controlled by controlling (or varying) a thickness of the metal layer. The metal layer may be plated or deposited on the base film. As the thickness of the metal layer decreases, the limiting current and/or maximum current of the anode current collectors 521b, 522b also decrease, thus improving the stability of the lithium battery during a short circuit. A lead-tab may be added on the metal layer for connection to the outside. The lead-tab may be welded to the metal layer or a metal layer/base film laminate by ultrasonic welding, laser welding, spot welding, or the like. If (e.g., when) the base film and/or the metal layer melt during welding, the metal layer may be electrically connected to the lead-tab.

For stronger welding between the metal layer and the lead tab, a metal chip may be added between the metal layer and the lead tab. The metal chip may be a flake of the same material as the metal of the metal layer. For example, the metal chip may be a metal foil, a metal mesh, or the like. For example, the metal chip may be an aluminum foil, a copper foil, an SUS foil, or the like. By welding the metal layer with the lead-tab after placing the metal chip on the metal layer, the lead-tab may be welded to a metal chip/metal layer laminate or a metal chip/metal layer/base film laminate. If (e.g., when) the base film, the metal layer, and/or the metal chip melt during welding, the metal layer or the metal layer/metal chip laminate may be electrically connected to the lead-tab. A metal chip and/or a lead-tab may be further added on a part of the metal layer. For example, the base film may have a thickness in a range of about 1 μm to about 50 μm, in a range of about 1.5 μm to about 50 μm, in a range of about 1.5 μm to about 40 μm, or in a range of about 1 μm to about 30 μm. If (e.g., when) the base film has a thickness within the above ranges, the weight of the electrode assembly may be effectively reduced. For example, the base film may have a melting point in a range of about 100° C. to about 300° C., in a range of about 100° C. to about 250° C. or less, or in a range of about 100° C. to about 200° C. If (e.g., when) the base film has a melting point within the above ranges, the base film may easily melt to be bonded to the lead-tab while welding the lead-tab. To improve adhesion between the base film and the metal layer, a surface treatment, such as corona treatment, may be performed on the base film. For example, the metal layer may have a thickness in a range of about 0.01 μm to about 3 μm, in a range of about 0.1 μm to about 3 μm, in a range of about 0.1 μm to about 2 μm, or in a range of about 0.1 μm to about 1 μm. If (e.g., when) the metal layer has a thickness within the above ranges, the electrode assembly may provide stability while maintaining conductivity. For example, the metal chip may have a thickness in a range of about 2 μm to about 10 μm, in a range of about 2 μm to about 7 μm, or in a range of about 4 μm to about 6 μm. If (e.g., when) the metal chip has a thickness within the above ranges, the metal layer and the lead-tab may be more easily connected. If (e.g., when) the anode current collector 521b, 522b has the above structure, the weight of the electrode may be reduced and, as a result, energy density may improve.

In one or more embodiments of the present disclosure, the cathode current collector 511b may be, for example, a plate, a foil, or the like, that is formed of indium (In), copper (Cu), magnesium (Mg), stainless steel (SUS), titanium (Ti), iron (Fe), cobalt (Co), nickel (Ni), zinc (Zn), aluminum (Al), germanium (Ge), lithium (Li), or an alloy thereof. The cathode current collector may have a thickness, for example, in a range of about 1 μm to about 100 μm, in a range of about 1 μm to about 50 μm, in a range of about 5 μm to about 25 μm, or in a range of about 10 μm to about 20 μm.

For example, the cathode current collector 511b may include a base film and a metal layer disposed on one surface or both surfaces of the base film. The base film may include, for example, a polymer. For example, the polymer may be a thermoplastic polymer. For example, the polymer may include polyethylene terephthalate (PET), polyethylene (PE), polypropylene (PP), polybutylene terephthalate (PBT), polyimide (PI), or a combination thereof. Due to inclusion of a thermoplastic polymer in the base film, the base film liquefies in the event of a short circuit and, thus, may prevent a rapid increase in electric current. For example, the base film may be an insulator. For example, the metal layer may include indium (In), copper (Cu), magnesium (Mg), stainless steel (SUS), titanium (Ti), iron (Fe), cobalt (Co), nickel (Ni), zinc (Zn), aluminum (Al), germanium (Ge), or an alloy thereof. The metal layer may be disconnected in the event of an overcurrent, thus acting as an electrochemical fuse to provide protection against short circuits. A limiting current and a maximum current may be controlled by controlling (e.g., varying) a thickness of the metal layer. The metal layer may be plated or deposited on the base film. As the thickness of the metal layer decreases, the limiting current and/or maximum current of the cathode current collector decrease, and therefore, the stability of the lithium battery during a short circuit may improve. A lead-tab may be added on the metal layer for connection to the outside. The lead-tab may be welded to the metal layer or a metal layer/base film laminate by ultrasonic welding, laser welding, spot welding, or the like. If (e.g., when) the base film and/or the metal layer melt during welding, the metal layer may be electrically connected to the lead-tab.

To further secure the welding between the metal layer and the lead-tab, a metal chip may be added between the metal layer and the lead-tab. The metal chip may be a flake of the same material as the metal of the metal layer. For example, the metal chip may be a metal foil, a metal mesh, or the like. For example, the metal chip may be an aluminum foil, a copper foil, an SUS foil, or the like. By welding the metal layer with the lead-tab after placing the metal chip on the metal layer, the lead-tab may be welded to a metal chip/metal layer laminate or a metal chip/metal layer/base film laminate. If (e.g., when) the base film, the metal layer, and/or the metal chip melt during welding, the metal layer or the metal layer/metal chip laminate may be electrically connected to the lead-tab. A metal chip and/or a lead-tab may be further added on a part of the metal layer. For example, the base film may have a thickness in a range of about 1 μm to about 50 μm, in a range of about 1.5 μm to about 50 μm, in a range of about 1.5 μm to about 40 μm, or in a range of about 1 μm to about 30 μm. If (e.g., when) the base film has a thickness within the above ranges, the weight of the electrode assembly may be effectively reduced. For example, the base film may have a melting point in a range of about 100° C. to about 300° C., in a range of about 100° C. to about 250° C. or less, or in a range of about 100° C. to about 200° C. If (e.g., when) the base film has a melting point within the above ranges, the base film may melt and be easily bonded to the lead-tab while welding the lead-tab. To improve adhesion between the base film and the metal layer, a surface treatment, such as corona treatment may be performed on the base film. For example, the metal layer may have a thickness in a range of about 0.01 μm to about 3 μm, in a range of about 0.1 μm to about 3 μm, in a range of about 0.1 μm to about 2 μm, or in a range of about 0.1 μm to about 1 μm. If (e.g., when) the metal layer has a thickness within the above ranges, the electrode assembly may provide stability while maintaining conductivity. For example, the metal chip may have a thickness in a range of about 2 μm to about 10 μm, in a range of about 2 μm to about 7 μm, or in a range of about 4 μm to about 6 μm. If (e.g., when) the metal chip has a thickness within the above ranges, the metal layer and the lead-tab may be more easily connected. If (e.g., when) the cathode current collector has the above structure, the weight of the cathode may be reduced, and as a result, energy density of the cathode and the lithium battery may improve.

In one or more embodiments of the present disclosure, the anode active material layers 521a, 522a may include, for example, a lithium foil, lithium powder, plated lithium, carbonaceous material, or a combination thereof. The anode active material layer including a lithium foil may be, for example, a lithium metal layer. The anode active material layer including lithium powder may be introduced by coating a slurry that includes a lithium powder, a binder, etc. onto an anode current collector. The binder may be, for example, a fluorine-based binder, such as polyvinylidene fluoride (PVDF). The anode active material layer may be free of carbon-based anode active materials. Thus, the anode active material layer may be formed of a metal-based anode active material. For example, the anode active material layer may be a plated lithium metal layer.

The thickness of the anode active material layer may be, for example, in a range of about 0.1 μm to about 100 μm, in a range of about 0.1 μm to about 80 μm, in a range of about 1 μm to about 80 μm, or in a range of about 10 μm to about 80 μm but, without being limited thereto, may be adjusted according to the shape, capacity, and the like of a lithium metal battery. If the thickness of the anode active material layer excessively increases, the structural stability of the lithium metal battery may deteriorate and side reactions may increase. If the thickness of the anode active material layer is excessively small, energy density of the lithium metal battery may deteriorate. The lithium foil may have a thickness, for example, in a range of about 1 μm to about 50 μm, in a range of about 1 μm to about 30 μm, in a range of about 10 μm to about 30 μm, or in a range of about 10 μm to about 80 μm. The lithium powder may have a particle diameter, for example, in a range of about 0.1 μm to about 3 μm, in a range of about 0.1 μm to about 2 μm, or in a range of about 0.1 μm to about 2 μm.

In one or more embodiments of the present disclosure, the cathode active material layers 511a, 512a may be formed by mixing a cathode active material, a conductive agent, a binder, and a solvent to prepare a cathode active material composition, and then, coating and drying the prepared cathode active material composition directly on a current collector. In other embodiments, the cathode active material layers may be formed by casting the cathode active material composition on a separate support, and then, laminating a film exfoliated from this support on the aluminum current collector.

The cathode active material, which is a lithium-containing metal oxide, may be (or may include) any lithium-containing metal oxide commonly available in the art without limitation. For example, the cathode active material may include at least one composite oxide of lithium with a metal selected from cobalt, manganese, nickel, and a combination thereof. For example, a compound represented by any one of the following formulae may be used: LiₐA_{1-b}B_{b}D₂ (wherein 0.90≤a≤1 and 0≤b≤0.5); LiₐE_{1-b}B_{b}O_{2-c}D_{c} (wherein 0.90≤a≤1, 0≤b≤0.5, and 0≤c≤0.05); LiE_{2-b}B_{b}O_{4-c}D_{c} (wherein 0≤b≤0.5 and 0≤c≤0.05); LiₐNi_{1-b-c}CO_{b}B_{c}D_{α} (wherein 0.90≤a≤1, 0≤b≤0.5, 0≤c≤0.05, and 0≤α≤2); LiₐNi_{1-b-c}CO_{b}B_{c}O_{2-α}F_{α} (wherein 0.90≤a≤1, 0≤b≤0.5, 0≤c≤0.05, and 0≤α≤2); LiₐNi_{1-b-c}CO_{b}B_{c}O_{2-α}F₂ (wherein 0.90≤a≤1, 0≤b≤0.5, 0≤c≤0.05, and 0≤α≤2); LiₐNi_{1-b-c}Mn_{b}B_{c}D_{α} 0.90≤a≤1, 0≤b≤0.5, 0≤c≤0.05, and 0≤α≤2); LiₐNi_{1-b-c}Mn_{b}B_{c}O_{2-α}F₂ (wherein 0.90≤a≤1, 0≤b≤0.5, 0≤c≤0.05, and 0≤α≤2); LiₐNi_{b}E_{c}GaO₂ (wherein 0.90≤a≤1, 0≤b≤0.9, 0≤c≤0.5, and 0.001≤d≤0.1); LiₐNi_{b}Co_{c}MnₐGeO₂ (wherein 0.90≤a≤1, 0≤b≤0.9, 0≤c≤0.5, 0≤d≤0.5, and 0.001≤e≤0.1); LiₐNiG_{b}O₂ (wherein 0.90≤a≤1 and 0.001≤b≤0.1); LiₐCoG_{b}O₂ (wherein 0.90≤a≤1 and 0.001≤b≤0.1); LiₐMnG_{b}O₂ (wherein 0.90≤a≤1 and 0.001≤b≤0.1); LiₐMn₂G_{b}O₄ (wherein 0.90≤a≤1 and 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); and LiFePO₄.

In the formulae representing the above-described compounds, A may be nickel (Ni), cobalt (Co), manganese (Mn), or a combination thereof; B may be aluminum (Al), Ni, Co, Mn, chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; E may be Co, Mn, or a combination thereof; F may be F, S, P, or a combination thereof; G may be Al, Cr, Mn, Fe, Mg, lanthanum (La), cerium (Ce), Sr, V, or a combination thereof; Q may be titanium (Ti), molybdenum (Mo), Mn, or a combination thereof; I may be Cr, V, Fe, Sc, yttrium (Y), or a combination thereof; and J may be V, Cr, Mn, Co, Ni, copper (Cu), or a combination thereof.

A coating layer may be provided on the surface of the above-described compound, and the resulting compound with such a coating layer may be utilized, or a mixture of the above-described compound and the compound with a coating layer may be utilized. The coating layer provided on the surface of the above-described compound may include a coating element compound, such as an oxide of a coating element, a hydroxide of a coating element, an oxyhydroxide of a coating element, an oxycarbonate of a coating element, or a hydroxycarbonate of a coating element. The compound constituting this coating layer may be amorphous or crystalline. The coating element included in the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or a mixture thereof. The method of forming the coating layer may be selected from one that does not adversely affect physical properties of the cathode active material. The coating method may be, for example, spray coating, a dipping method, and/or the like. A detailed description of the coating method will not be provided as it is well understood by those in the art.

For example, the cathode active material may be LiₐNiₓCo_{y}M_{z}O_{2-b}A_{b} (1.0≤a≤1.2, 0≤b≤0.2, 0.8≤x<1, 0<y≤0.3, 0<z≤0.3, and x+y+z=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B) or a combination thereof, and A is fluorine (F), sulfur (S), chlorine (Cl), bromine (Br), or a combination thereof), LiNiₓCo_{y}Mn_{z}O₂ (0.8≤x≤0.95, 0≤y≤0.2, 0<z≤0.2, and x+y+z=1), LiNiₓCo_{y}Al_{z}O₂ (0.8≤x≤0.95, 0≤y≤0.2, 0<z≤0.2, and x+y+Z=1), LiNiₓCo_{y}Mn_{z}Al_{w}O₂ (0.8≤x≤0.95, 0≤y≤0.2, 0<z≤0.2, 0<w≤0.2, and X+y+z+W=1), LiₐCoₓM_{y}O_{2-b}A_{b} (1.0≤a≤1.2, 0≤b≤0.2, 0.9≤x≤1, 0≤y≤0.1, and x+y=1, M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is fluorine (F), sulfur (S), chlorine (Cl), bromine (Br), or a combination thereof), LiₐNiₓMn_{y}M′_{z}O_{2-b}A_{b} (1.0≤a≤1.2, 0≤b≤0.2, 0<x≤0.3, 0.5≤y<1, 0<z≤0.3, and x+y+z=1, M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A is fluorine (F), sulfur (S), chlorine (Cl), bromine (Br), or a combination thereof), LiₐM1ₓM2_{y}PO_{4-b}X_{b} (0.90≤a≤1.1, 0≤x≤0.9, 0≤y≤0.5, 0.9<x+y<1.1, and 0≤b≤2, M1 is chromium (Cr), manganese (Mn), iron (Fe), cobalt (Co), nickel (Ni), copper (Cu), zirconium (Zr), or a combination thereof, and M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X is O, F, S, P, or a combination thereof), or LiₐM_{3z}PO₄ (0.90≤a≤1.1 and 0.9≤z≤1.1, and M3 is chromium (Cr), manganese (Mn), iron (Fe), cobalt (Co), nickel (Ni), copper (Cu), zirconium (Zr), or a combination thereof).

The conductive material may be (or may include) carbon black, graphite fine particles, natural graphite, artificial graphite, acetylene black, Ketjen black, carbon fiber; carbon nanotubes, metal powder, metal fiber, or metal tube (such as copper, nickel, aluminum, and silver), or conductive polymers, such as polyphenylene derivatives, but the present disclosure is not limited thereto. Any conductive material available in the art may be utilized. In some embodiments, the cathode may not contain any conductive material.

The binder may be (or may include) a vinylidene fluoride/hexafluoropropylene copolymer, polyvinylidene fluoride, polyacrylonitrile, polymethyl methacrylate, polytetrafluoroethylene (PTFE), a mixture of the above-described polymers, and/or a styrene butadiene rubber polymer but the present disclosure is not limited thereto. Any suitable binder in the art may be utilized. The solvent may be (or may include) N-methylpyrrolidone (NMP), acetone, and/or water but the present disclosure is not limited thereto. Any solvent available in the art may be utilized.

Pores may be formed in the electrode plate by further adding a plasticizer or a pore former to the cathode active material composition.

The amount of each of the cathode active material, the conductive material, the binder, and the solvent used in the cathode may be at a level commonly used in a lithium battery. Depending on the use and configuration of the lithium battery, one or more of the conductive material, the binder, and the solvent may be omitted.

The amount of the binder included in the cathode may be in a range of about 0.1 wt % to about 10 wt % or in a range of about 0.1 wt % to about 5 wt % relative to the total weight of the cathode active material layer. The amount of the cathode active material included in the cathode may be in a range of about 80 wt % to about 99 wt %, in a range of about 90 wt % to about 99 wt %, or in a range of about 95 wt % to about 99 wt % with respect to the total weight of the cathode active material layer.

In one or more embodiments of the present disclosure, the electrode assembly 50 may include a liquid electrolyte, a gel electrolyte, a solid electrolyte, or a combination thereof. Because the solid electrolyte has a relatively low flowability, in an embodiment of the electrode assembly 50 including a solid electrolyte, pressing the electrode assembly 50 with adjacent electrode layers (e.g., the cathode layer 51 and the anode layer 52) by a relatively higher contact pressure may be more advantageous for output characteristics of the battery units B. In one or more embodiments of the present disclosure, by pressing the electrode assembly 50 of each battery unit B arranged along the first axis Z1 with a high pressure from a binding force provided during an assembly process of the battery pack P, swelling associated with an increased thickness of the electrode assembly 50 may be effectively inhibited, and for example, it is possible to inhibit swelling and prevent deterioration in output of the battery unit B due to an uneven pressure or the like between the electrolyte layer 55 including a solid electrolyte and the electrode layers (e.g., the cathode layer 51 and the anode layer 52) caused by swelling. Further, output deterioration due to a faulty contact or an uneven contact pressure between the electrolyte layer including solid electrolyte and the electrode layers may be prevented.

Examples of the solid electrolyte may include an oxide-based solid electrolyte, a sulfide-based solid electrolyte, a polymer solid electrolyte, or a combination thereof.

The solid electrolyte may be, for example, an oxide-based solid electrolyte. The oxide-based solid electrolyte may be at least one selected from among Li_{1+x+y}AlₓTi₂₋ₓSi_{y}P_{3-y}O₁₂ (0<x<2 and 0≤y<3), BaTiO₃, Pb(Zr,Ti)O₃ (PZT), Pb₁₋ₓLaₓZr_{1-y}Ti_{y}O₃ (PLZT) (0≤x<1 and 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2 and 0<y<3), LiₓAl_{y}Ti_{z}(PO₄)₃ (0<x<2, 0<y<1, and 0<z<3), Li_{1+x+y}(Al, Ga)ₓ(Ti, Ge)₂₋ₓSi_{y}P_{3-y}O₁₂ (0≤x≤1 and 0≤y≤1), LiₓLa_{y}TiO₃ (0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (M=Te, Nb, or Zr, and x is an integer of 1 to 10). The solid electrolyte may be prepared by a sintering method or the like. For example, the oxide-based solid electrolyte may be a garnet-type solid electrolyte selected from Li₇La₃Zr₂O₁₂ (LLZO) and Li₃₊ₓLa₃Zr₂₋ₐMₐO₁₂ (M-doped LLZO wherein M=Ga, W, Nb, Ta, or Al, and x is an integer of 1 to 10).

In one or more embodiment of the present disclosure, at least part of the solid electrolyte may be sintered by the compressive force provided by the binding mechanism 85.

For example, the sulfide-based solid electrolyte may be at least one selected from among Li₂S—P₂S₅, Li₂S—P₂S₅—LiX wherein X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ wherein m and n each are a positive number and Z is one of Ge, Zn or Ga, Li₂S—GeS₂, Li₂S—SiS₂—Li₃PO₄, Li₂S—SiS₂—LiₚMO_{q} (wherein p and q are a positive number and M is one of P, Si, Ge, B, Al, Ga, and In), Li₃PS₄, Li₇P₃S₁₁, Li₇₋ₓPS₆₋ₓClₓ (0£x£2), Li₇₋ₓPS₆₋ₓBrₓ (0£x£2), and Li₇₋ₓPS₆₋ₓIₓ (0£x£2). The sulfide-based solid electrolyte may be prepared by treating starting materials, such as Li₂S and P₂S₅, by a method such as melt-quenching, mechanical milling, and the like. In some embodiments, following such a treatment, heat treatment may be conducted. The solid electrolyte may be amorphous or crystalline or may be in a mixed state thereof. In some embodiments, the solid electrolyte may be, from among the sulfide-based solid electrolyte materials described herein, for example, a material containing at least sulfur (S), phosphorus (P), and lithium (Li) as its constitutive elements. For example, the solid electrolyte may be a material including Li₂S—P₂S₅. If (e.g., when) a material containing Li₂S—P₂S₅ is used as the sulfide-based solid electrolyte material constituting the solid electrolyte, the mixing molar ratio of Li₂S and P₂S₅ may be, for example, in a range of Li₂S:P₂S₅=about 50:50 to about 90:10. For example, the sulfide-based solid electrolyte may include an argyrodite-type solid electrolyte represented by Formula A:

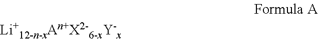

In Formula A, A may be P, As, Ge, Ga, Sb, Si, Sn, Al, In, Ti, V, Nb, or Ta, X may be S, Se, or Te, Y may be Cl, Br, I, F, CN, OCN, SCN, or N₃, and 1≤n≤5 and 0£x£2 may be satisfied. For example, the sulfide-based solid electrolyte may be an argyrodite-type compound including one or more selected from Li₇₋ₓPS₆₋ₓClₓ wherein 0≤x≤2, Li₇₋ₓPS₆₋ₓBrₓ wherein 0≤x≤2, and Li₇₋ₓPS₆₋ₓIₓ wherein 0≤x≤2. For example, the sulfide-based solid electrolyte may be an argyrodite-type compound including at least one selected from Li₆PS₅Cl, Li₆PS₅Br, and Li₆PS₅I. An argyrodite-type solid electrolyte may have a density in a range of about 1.5 g/cc to about 2.0 g/cc. Because the argyrodite-type solid electrolyte has a density of about 1.5 g/cc or more, the internal resistance of a battery unit B may be reduced, and Li penetration into the solid electrolyte may be more effectively suppressed.

For example, the sulfide-based solid electrolyte may have an elastic modulus in a range of about 40 GPa or less. For example, the sulfide-based solid electrolyte may have an elastic modulus in a range of about 5 GPa to about 40 GPa, in a range of about 10 GPa to about 40 GPa, or in a range of about 15 GPa to about 30 GPa.

For example, sulfide-based solid electrolyte particles may have an average particle diameter in a range of about 1 μm to about 50 μm, in a range of about 3 μm to about 30 μm, or in a range of about 3 μm to about 20 μm. If (e.g., when) the sulfide-based solid electrolyte particles have an average particle diameter in the above ranges, cycle characteristics of a battery unit B and a battery pack P including the same may be further improved.

For example, the polymer solid electrolyte may include a mixture of a lithium salt and a polymer or may include a polymer having an ion-conducting functional group. For example, the polymer solid electrolyte may be a polymer electrolyte that is in a solid state at 25° C. and 1 atm. For example, the polymer solid electrolyte may not contain liquid. The polymer solid electrolyte may include a polymer. For example, the polymer may be polyethylene oxide (PEO), polyvinylidene fluoride (PVDF), vinylidene fluoride-hexafluoropropylene (PVDF-HFP), polyethylene oxide (PEO), a poly(styrene-b-ethylene oxide) block copolymer (PS-PEO), poly(styrene-butadiene), poly(styrene-isoprene-styrene), a poly(styrene-b-divinylbenzene) block copolymer, a poly(styrene-ethylene oxide-styrene) block copolymer, polystyrene sulfonate (PSS), polyvinyl fluoride (PVF), poly(methyl methacrylate) (PMMA), polyethylene glycol (PEG), polyacrylonitrile (PAN), polytetrafluoroethylene (PTFE), polyethylene dioxythiophene (PEDOT), polypyrrole (PPy), polyacrylonitrile (PAN), polyaniline, polyacetylene, a polytetrafluoroethylene (PTFE) backbone material with perfluorinated-vinyl-polyether side chains containing sulphonic acid end group, short-side-chain perfluorinated sulfonic-acid (PFSA), a fluorinated ion exchange membrane, expanded polytetrafluoroethylene (ePTFE), perfluorosulfonic acid, poly(vinyl alcohol) (PVA), sulfonated poly(ether ether ketone) (SPEEK), sulfonated poly(arylene ether ketone ketone sulfone) (SPAEKKS), sulfonated poly(aryl ether ketone) (SPAEK), poly[bis(benzimidazobenzisoquinolinones)] (SPBIBI), poly(styrene sulfonate) (PSS), and lithium 9,10-diphenylanthracene-2-sulfonate (DPASLi+), or a combination thereof. However, the polymer is not limited to the aforementioned examples and may be any material available in the art that is used in polymer electrolyte. The lithium salt may be any lithium salt available in the art. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each an integer of 1 to 20), LiCl, LiI, or a mixture thereof. For example, the polymer included in the polymer solid electrolyte may be a compound having 10 or more repeating units, 20 or more repeating units, 50 or more repeating units, or 100 or more repeating units. For example, the polymer included in the polymer solid electrolyte may have a weight average molecular weight in a range of about 1,000 Dalton or more, in a range of about 10,000 Dalton or more, in a range of about 100,000 Dalton or more, or in a range of about 1,000,000 Dalton or more.

For example, the gel electrolyte may be a polymer gel electrolyte. For example, the gel electrolyte may be in a gel state while not containing a polymer.

For example, the polymer gel electrolyte may include a liquid electrolyte and a polymer or an organic solvent and a polymer having an ion-conducting functional group. For example, the polymer gel electrolyte may be a polymer electrolyte that is in a gel state at 25° C. and 1 atm. For example, the polymer gel electrolyte may have a gel state without containing liquid. The liquid electrolyte used in the polymer gel electrolytes may be, for example, a mixture of an ionic liquid, a lithium salt, and an organic solvent; a mixture of a lithium salt and an organic solvent; a mixture of an ionic liquid and an organic solvent; or a mixture of a lithium salt, an ionic liquid, and an organic solvent. The polymer used in the polymer gel electrolyte may be selected from polymers used in solid polymer electrolytes. The organic solvent may be selected from organic solvents used in liquid electrolytes. The lithium salt may be selected from lithium salts used in polymer solid electrolytes. The ionic liquid may refer to a room-temperature molten salt or a salt that is in a liquid state at room temperature, which only consists of ions and has a melting point of room temperature or lower. For example, the ionic liquid may be at least one selected from compounds containing: a) at least one cation selected from ammonium, pyrrolidinium, pyridinium, pyrimidinium, imidazolium, piperidinium, pyrazolium, oxazolium, pyridazinium, phosphonium, sulfonium, triazolium, and a mixture thereof; and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻. For example, the polymer solid electrolyte may form a polymer gel electrolyte by impregnation in a liquid electrolyte in a secondary battery. The polymer gel electrolyte may further include inorganic particles. For example, the polymer included in the polymer gel electrolyte may be a compound having 10 or more repeating units, 20 or more repeating units, 50 or more repeating units, or 100 or more repeating units. For example, the polymer included in the polymer gel electrolyte may have a weight average molecular weight in a range of about 500 Dalton or more, in a range of about 1,000 Dalton or more, in a range of about 10,000 Dalton or more, in a range of about 100,000 Dalton or more, or in a range of about 1,000,000 Dalton or more.

For example, the solid electrolyte may be at least partially or completely sintered by the compressive force provided by the binding mechanism 85 and, thus, may form a more stable solid electrolyte structure. The compressive force F illustrated in FIG. 7 and FIG. 10 indicates the direction of compressive force F that is primarily generated from the coupling of the first coupling member 84a and the second coupling member 84b of the coupling mechanism 84, and therefore, subsequently, the compressive force F may be generated in both directions, including the above direction and the other direction opposite thereto, through interferences between battery units B.

In one or more embodiment of the present disclosure, the electrode assembly 50 may include a solid electrolyte having a lower flowability than liquid electrolytes, for example, an oxide-based solid electrolyte, a sulfide-based solid electrolyte, a polymer solid electrolyte, or a combination thereof. Thus, even if pressured by a compressive force or a binding force transmitted to adjacent battery units B, the risk of electrolyte leakage may be reduced.

One or more embodiments of the present disclosure have been described herein with reference to the drawings; however, these embodiments are merely examples, and it should be understood by those skilled in the art that various modifications thereto and equivalent other embodiments are also possible.

According to an aspect of embodiments of the present disclosure, by including a binding mechanism to physically bind a plurality of battery units together, effective compression may be provided to electrode assemblies constituting the inside of the battery units by a binding force that physically binds the plurality of battery units together in an array of the plurality of battery units arranged along a first axis.

According to another aspect of embodiments of the present disclosure, by using an electrode assembly that includes a solid electrolyte, which does not have leakage issues that conventional liquid electrolytes have, and by including a binding mechanism for physically binding together a plurality of battery units including the electrode assembly, effective compression of the electrode assembly may be achieved.

According to another aspect of embodiments of the present disclosure, while applying an electrode assembly including a plurality of electrode layers to provide high output, high voltage, and high capacity, it is possible to prevent output deterioration due to increased swelling of the electrode assembly, accompanied by relatively increased thickness, and for example, it is possible to prevent output deterioration caused by a faulty contact or an uneven contact pressure between the electrode layers and an electrolyte layer including a solid electrolyte.

According to another aspect of embodiments of the present disclosure, by further including, in addition to the binding mechanism, a coupling mechanism that increases ease of assembly of the binding mechanism, effective compression of electrode assemblies constituting the inside of the battery units may be achieved by a binding force that physically binds together a plurality of battery units in an array of battery units arranged along a first axis, and furthermore, swelling that may be prominent in a thicker electrode assembly may be effectively inhibited.

It should be understood that the embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims and their equivalents.

What is claimed is:

1. A battery pack comprising:
a plurality of battery units arranged along a first axis; and
a binding mechanism configured to provide a binding force to physically bind together the plurality of battery units, the binding mechanism comprising:
a front end plate and a rear end plate respectively at outer sides of one end position and another end position of the plurality of battery units along the first axis;
a pair of side plates connecting the front end plate and the rear end plate to each other and extending across side surfaces of the plurality of battery units; and
a coupling mechanism connecting at least one of the front end plate and the rear end plate with the pair of side plates.

2. The battery pack as claimed in claim 1, wherein the binding mechanism is configured to compressive the plurality of battery units.

3. The battery pack as claimed in claim 1, wherein the binding mechanism is configured to provide a compressive force to one side or both sides of the plurality of battery units,
wherein a first thickness is a total thickness of the plurality of battery units after being compressed by the binding mechanism, and a second thickness is a total thickness of the plurality of battery units arranged along the first axis before being compressed by the binding mechanism, and
wherein the first thickness is 99% or less of the second thickness.

4. The battery pack as claimed in claim 1, wherein the coupling mechanism further comprises:
a first coupling member integrally formed with the front end plate; and
a second coupling member coupled to the first coupling member and opposing a second side of the rear end plate.

5. The battery pack as claimed in claim 1, wherein the coupling mechanism further comprises a first coupling member and a second coupling member,
wherein the first coupling member comprises:
a protruding portion contacting a second side of the front end plate; and
an extending portion extending from the protruding portion, and
wherein the second coupling member is coupled to the first coupling member and opposes a second side of the rear end plate.

6. The battery pack as claimed in claim 5, wherein the front end plate has an end plate through-hole therein,
wherein the pair of side plates each has a side plate through-hole formed therein, and
wherein the rear end plate has an end plate coupling hole formed therein.

7. The battery pack as claimed in claim 6, wherein the first coupling member sequentially passes through the end plate through-hole, the side plate through-hole, and the end plate coupling hole, and
wherein the second coupling member is coupled to an end of the first coupling member having sequentially passed through the end plate through-hole, the side plate through-hole, and the end plate coupling hole.

8. The battery pack as claimed in claim 6, wherein the end plate through-hole is in an area of the front end plate on a plane of contact between the front end plate and the pair of side plates.

9. The battery pack as claimed in claim 6, wherein the side plate through-hole is within the side plates and extends parallel to the first axis.

10. The battery pack as claimed in claim 6, wherein the end plate coupling hole is in an area of the rear end plate on a plane of contact between the rear end plate and the pair of side plates.

11. The battery pack as claimed in claim 6, the coupling mechanism further comprises a plurality of the first coupling members and a plurality of the second coupling members, and
wherein a number of each of the end plate through-holes, the side plate through-holes, and the end plate coupling holes corresponds to a number of the first coupling members and a number of the second coupling members.

12. The battery pack as claimed in claim 6, wherein the front end plate has a plurality of the end plate through-holes, and
wherein the plurality of end plate through-holes are adjacent in a direction parallel to a plane of contact between the front end plate and the pair of side plates and perpendicular to the first axis.

13. The battery pack as claimed in claim 12, wherein the plurality of end plate through-holes are spaced apart from each other.

14. The battery pack as claimed in claim 6, wherein the pair of side plates each has a plurality of the side plate through-holes arranged along a plane of contact between the side plates and the pair of end plates, and
wherein any one of the side plate through-holes extends in a direction perpendicular to the plane of contact between the side plates and the pair of end plates and parallel to the first axis.

15. The battery pack as claimed in claim 14, wherein the plurality of side plate through-holes are spaced apart from each other.

16. The battery pack as claimed in claim 6, wherein the rear end plate has a plurality of the end plate coupling holes, and
wherein the plurality of end plate coupling holes are adjacent to each other in a direction parallel to a plane of contact between the rear end plate and the pair of side plates and perpendicular to the first axis.

17. The battery pack as claimed in claim 16, wherein the plurality of end plate coupling holes are spaced apart from each other.

18. The battery pack as claimed in claim 1, wherein each of the plurality of battery units comprises:
an electrode assembly comprising a plurality of electrode layers stacked along the first axis; and
a case accommodating the electrode assembly.

19. The battery pack as claimed in claim 18, wherein the electrode assembly further comprises an electrolyte layer between the electrode layers having different polarities from each other along the first axis,
wherein the electrolyte layer comprises at least one of:
a liquid electrolyte,
a solid electrolyte comprising an oxide-based solid electrolyte, a sulfide-based solid electrolyte, a polymer solid electrolyte, or a combination thereof, at least a part of the solid electrolyte being sintered by a compressive force provided by the binding mechanism; and
a gel electrolyte comprising a polymer gel electrolyte.

20. The battery pack as claimed in claim 18, wherein the electrode layers comprise a cathode layer and an anode layer,
wherein the cathode layer comprises a cathode current collector, and the anode layer comprises an anode current collector,
wherein at least one of the cathode current collector and the anode current collector comprises a base film and a metal layer on at least one side of the base film,
wherein the base film comprises a polymer comprising polyethylene terephthalate (PET), polyethylene (PE), polypropylene (PP), polybutylene terephthalate (PBT), polyimide (PI), or a combination thereof, and
wherein the metal layer comprises indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.
